(19) United States
(12) Patent Application Publication
(10) Pub. No.: US 2011/0138060 A1
(43) Pub. Date: Jun. 9, 2011

(54) METHOD AND APPARATUS FOR SESSION DUPLICATION AND SESSION SHARING

(75) Inventors: Debashish Purkayastha, Collegeville, PA (US); Kamel M. Shaheen, King of Prussia, PA (US)

(73) Assignee: INTERDIGITAL PATENT HOLDINGS, INC., Wilmington, DE (US)

(21) Appl. No.: 12/963,236

(22) Filed: Dec. 8, 2010

Related U.S. Application Data
(60) Provisional application No. 61/267,992, filed on Dec. 9, 2009.
(60) Provisional application No. 61/267,986, filed on Dec. 9, 2009.

(51) Int. Cl. G06F 15/16

(52) U.S. Cl. 709/227

(57) ABSTRACT

A method and apparatus for session duplication within the advanced multimedia system (AMS) framework are disclosed. The method includes duplicating a session running on a first application or device on a second application or device. A method and apparatus for sharing media is disclosed. The method includes sharing media running on a first application or device with a second application or device.

### CROSS REFERENCE TO RELATED APPLICATIONS

This application claims the benefit of U.S. Provisional Application No. 61/267,992, filed on Dec. 9, 2009, and U.S. Provisional Application No. 61/267,986, filed on Dec. 9, 2009, the contents of which are hereby incorporated by reference herein.

### FIELD OF INVENTION

This application is related to wireless communications.

### BACKGROUND

Multimedia applications have opened up a variety of tasks and features to be enjoyed by the public. It is now possible to surf the Internet from a cellular phone, send a text message to a friend across the country, listen to streaming audio, or watch streaming video. To access these services, a session is established with an entity that provides the services, for example, an advanced multimedia system (AMS). The AMS operates in accordance with a set of electronic communication protocols that allow multiple devices and software agents to coordinate for providing the user with a rich multimedia communication experience.

FIG. 1 shows architecture of an AMS system 100. The AMS system includes application/device 105 that may include projector, printer, smart phone, audio player, television (TV)/video monitor, laptop, and the like. The application/device 105 is configured to communicate with a wireless transmit/receive unit (WTRU) or any other user device 110. The WTRU or any other user device 110 is configured to communicate with the next generation network (NGN) services 120, which is in communication with a service node (SN) 130 and a network service facility (NSF) 140.

The WTRU 110 may include transport layer 112, NGN service functions 114, and H.325 container 116. The H.325 container is a function that represents the user to the network. The H.325 container includes sub-functions as application registry (AR) 117, orchestration manager (OM) 118, and transport agent (TA) 119. The container is more like a personal that moves with the user (i.e., WTRU). The container function is not restricted to be in a home gateway, home NodeB, set top box, and the like. The container may communicate among them to manage the communication. The AR 117 is the entity where individual applications register to declare their availability to a particular container. The OM 118 coordinates events between the applications to create an AMS session. The TA 119 manages the signaling between AMS assemblages. An AMS assemblage is a set of AMS elements that represent the logical association between the elements required for user interaction. For example, in AMS, a video conference that includes voice and video elements may be referred to as an AMS Assemblage. The NSF 140 provides transcoding and other functions. The SN 130 maintains a network level view of services available and may communicate with the OM 118 to locate devices.

FIG. 2 shows a basic call setup scenario 200. The applications/devices 205 receive an indication from the AR 210 for discovery. The applications/devices 205 sends a register request to the AR 210. The AR 210 combines all the applications application descriptions (ADs), identities (IDs), and the like. The ADs are defined using XML like language, so that a container has detailed knowledge about the application and the device it is running on. The AR forwards a register request to the OM 215. The OM 215 initiates interaction with the user. The OM 215 sends a register confirmation message to the AR 210, which forwards the register confirmation to the applications/devices 205. The user initiates communication from the OM 215. The OM 215 sends a pre-invoke request message to the AR 210, which forwards the pre-invoke request message to the applications/devices 205. The applications/devices 205 send a pre-invoke confirmation message to the AR 210, which forwards the pre-invoke confirmation message to the OM 215. The OM 215 sends a connect request message to the TA 220, which forwards the connect request message to the network. The TA 220 receives the connect alert and connect confirmation message over the NGN. The TA 220 forwards the connect confirm message to the OM 215, which sends an invoke request message to the AR 210, which send the invoke request message to the applications/devices 205. The applications/devices 205 sends an invoke confirmation message to the AR 210, which sends the invoke confirmation message to the OM 215, which sends the invoke confirmation message to the TA 220. The resources between source and sink pairs with different requirements (i.e., delay, bandwidth, jitter) are reserved. The communication starts and the media flows directly between the applications/devices 205 through the network.

However, occasionally during an established session, a user may be interrupted or the user may choose to move away from the session for his viewing pleasure. Therefore, it would be beneficial to provide a method and apparatus for session duplication and a method and apparatus for sharing media.

### SUMMARY

A method and apparatus for session duplication within the AMS framework are disclosed wherein a session running on a first application/device is duplicated on a second application/device. A method and apparatus for sharing media is disclosed wherein a media running on a first application/device is shared with a second application/device.

A mediation device is disclosed for use in an H.325 network comprising an application registry configured to register an application and determine whether a session is running on a first application, and an orchestration manager configured to detect that a user has triggered a session duplication on a second application, send a duplication request to a network for a connection establishment between the first application and the second application, and receive a message confirming the connection establishment from the network on a condition that the network has initiated connection establishment with the second application.

A mediation device is disclosed for use in an H.325 network comprising an application registry configured to register a first application and a second application, an orchestration manager configured to receive a trigger for a session setup request on the second application, the orchestration manager configured to send a message to the application registry seeking whether the second application is available and that the second application is capable of running same session as the one running on the first application, and upon receiving an acknowledgement of verification, the orchestration manager configured to send a request for transcoder download to a network.

A computer-readable storage medium, is disclosed, containing instructions, which when executed in a mediation device for use in an H.325 network, cause the mediation device to perform a method comprising registering a first application and a second application, receiving a trigger for a session setup request on the second application, sending a message seeking whether the second application is available and that the second application is capable of running same session as the one running on the first application, and upon receiving an acknowledgement of verification, sending a request for transcoder download to a network.

### BRIEF DESCRIPTION OF THE DRAWINGS

A more detailed understanding may be had from the following description, given by way of example in conjunction with the accompanying drawings wherein:

FIG. 1 shows an architecture of an AMS;

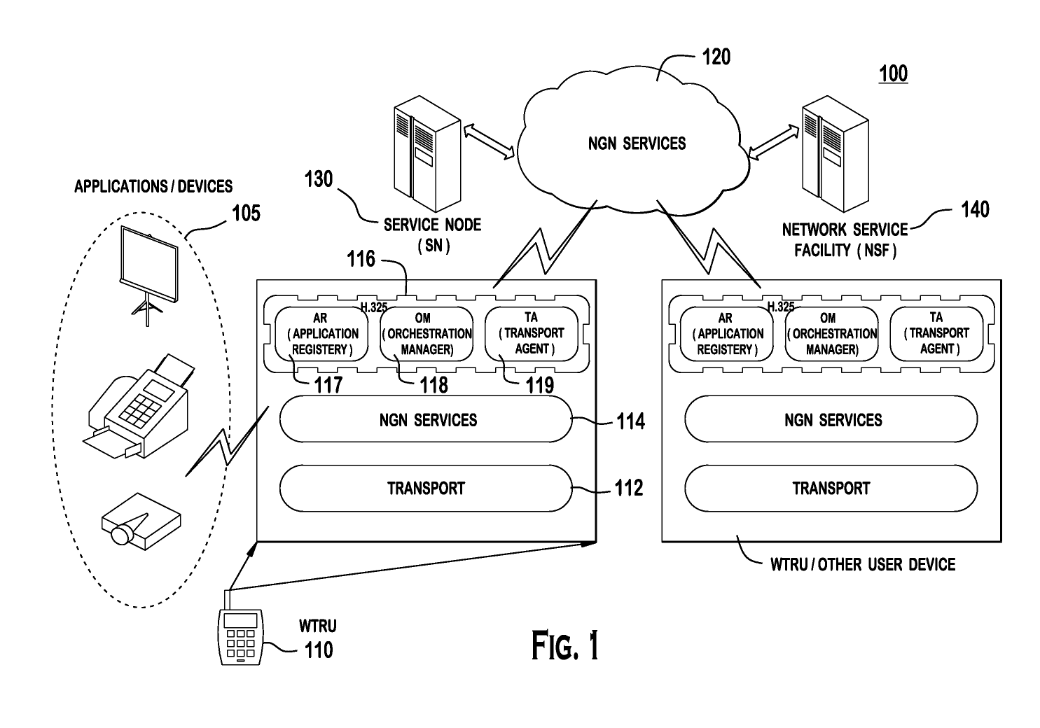

FIG. 2 shows a signal diagram of a call setup scenario;

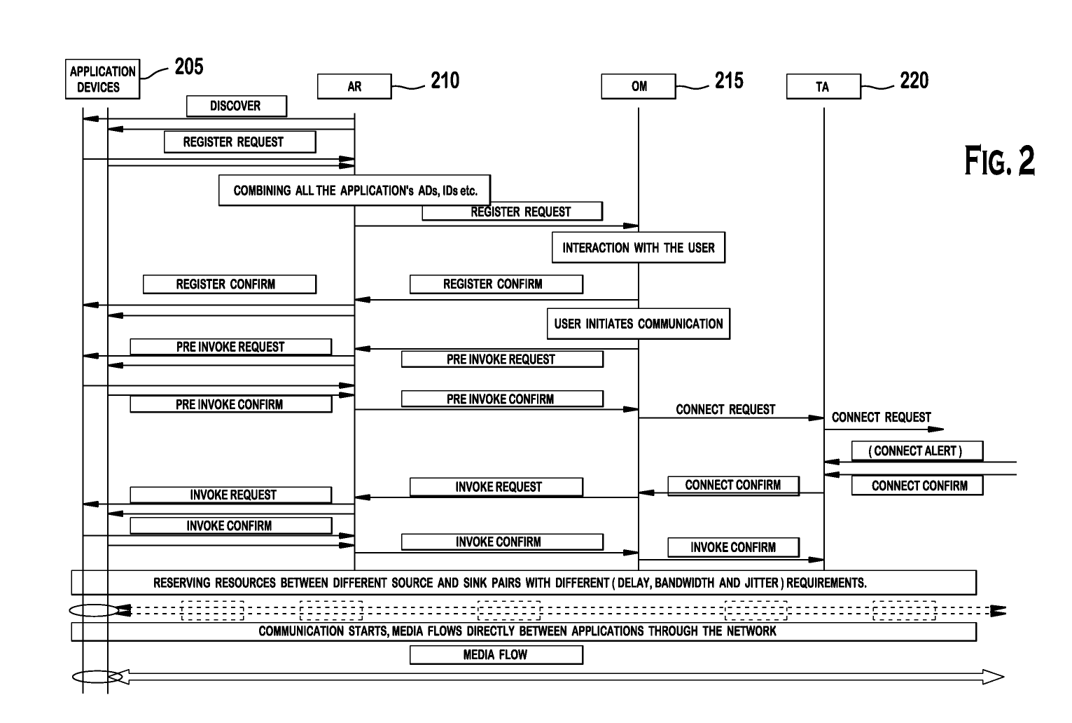

FIG. 3A is a system diagram of an example communications system in which one or more disclosed embodiments may be implemented;

FIG. 3B is a system diagram of an example wireless transmit/receive unit (WTRU) that may be used within the communications system illustrated in FIG. 3A;

FIG. 3C is a system diagram of an example radio access network and an example core network that may be used within the communications system illustrated in FIG. 3A;

FIG. 4 is a flow diagram of a session duplication scenario from a mediation device perspective in accordance with an embodiment;

FIG. 5 shows a signal diagram of a session duplication scenario;

FIG. 6 shows a flow diagram of a proposed method for a media sharing scenario in accordance with an embodiment; and

FIG. 7 shows a signal diagram of a media sharing scenario.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

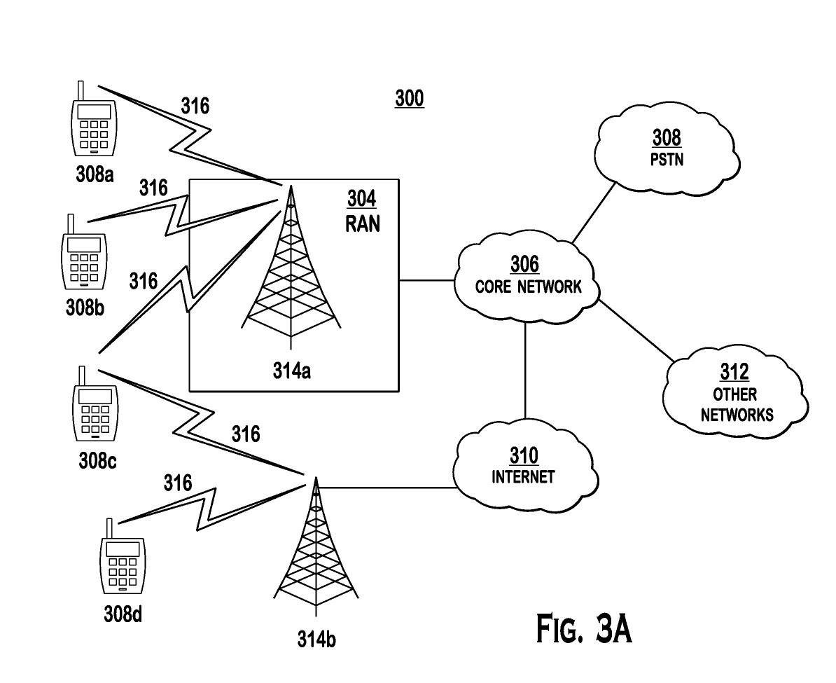

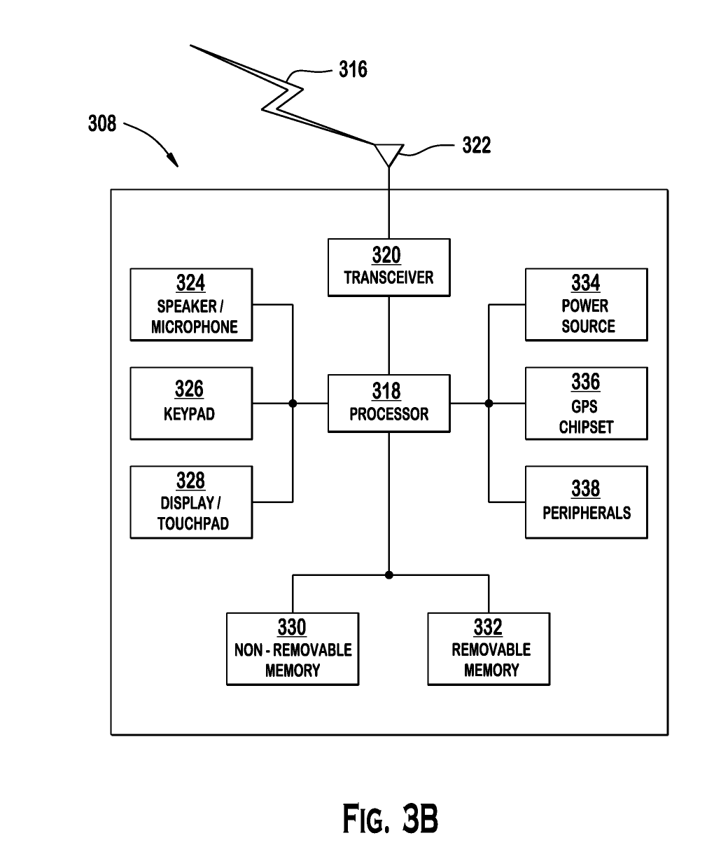

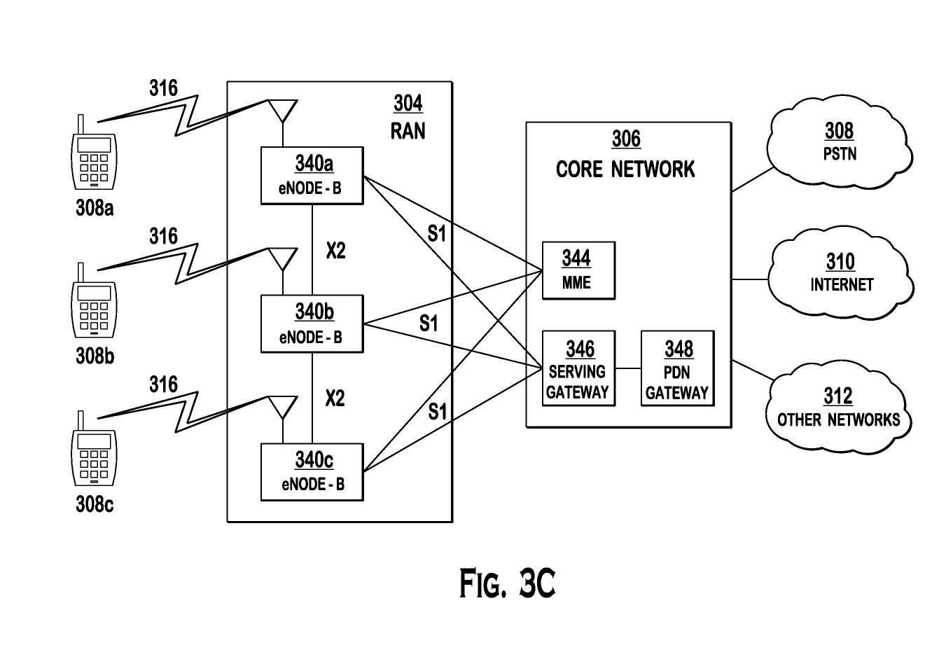

FIG. 3A is a diagram of an example communications system 300 in which one or more disclosed embodiments may be implemented. The communications system 300 may be a multiple access system that provides content, such as voice, data, video, messaging, broadcast, etc., to multiple wireless users. The communications system 300 may enable multiple wireless users to access such content through the sharing of system resources, including wireless bandwidth. For example, the communications systems 300 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 3A, the communications system 300 may include wireless transmit/receive units (WTRUs) 308a, 308b, 308c, 308d, a radio access network (RAN) 304, a core network 306, a public switched telephone network (PSTN) 308, the Internet 310, and other networks 312, though it will be appreciated that the disclosed embodiments contemplate any number of WTRUs, base stations, networks, and/or network elements. Each of the WTRUs 308a, 308b, 308c, 308d may be any type of device configured to operate and/or communicate in a wireless environment. By way of example, the WTRUs 308a, 308b, 308c, 308d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 300 may also include a base station 314a and a base station 314b. Each of the base stations 314a, 314b may be any type of device configured to wirelessly interface with at least one of the WTRUs 308a, 308b, 308c, 308d to facilitate access to one or more communication networks, such as the core network 306, the Internet 310, and/or the networks 312. By way of example, the base stations 314a, 314b may be a base transceiver station (BTS), a Node-B, an eNode B, a Home Node B, a Home eNode B, a site controller, an access point (AP), a wireless router, and the like. While the base stations 314a, 314b are each depicted as a single element, it will be appreciated that the base stations 314a, 314b may include any number of interconnected base stations and/or network elements.

The base station 314a may be part of the RAN 304, which may also include other base stations and/or network elements (not shown), such as a base station controller (BSC), a radio network controller (RNC), relay nodes, etc. The base station 314a and/or the base station 314b may be configured to transmit and/or receive wireless signals within a particular geographic region, which may be referred to as a cell (not shown). The cell may further be divided into cell sectors. For example, the cell associated with the base station 314a may be divided into three sectors. Thus, in one embodiment, the base station 314a may include three transceivers, i.e., one for each sector of the cell. In another embodiment, the base station 314a may employ multiple-input multiple output (MIMO) technology and, therefore, may utilize multiple transceivers for each sector of the cell.

The base stations 314a, 314b may communicate with one or more of the WTRUs 308a, 308b, 308c, 308d over an air interface 316, which may be any suitable wireless communication link (e.g., radio frequency (RF), microwave, infrared (IR), ultraviolet (UV), visible light, etc.). The air interface 316 may be established using any suitable radio access technology (RAT).

More specifically, as noted above, the communications system 300 may be a multiple access system and may employ one or more channel access schemes, such as CDMA, TDMA, FDMA, OFDMA, SC-FDMA, and the like. For example, the base station 314a in the RAN 304 and the WTRUs 308a, 308b, 308c may implement a radio technology such as Universal Mobile Telecommunications System (UMTS) Terrestrial Radio Access (UTRA), which may establish the air interface 316 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 314a and the WTRUs 308a, 308b, 308c may implement a radio technology such as Evolved UMTS Terrestrial Radio Access (E-UTRA), which may establish the air interface 316 using Long Term Evolution (LTE) and/or LTE-Advanced (LTE-A).

In other embodiments, the base station 314a and the WTRUs 308a, 308b, 308c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 314b in FIG. 3A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 314b and the WTRUs 308c, 308d may implement a radio technology such as IEEE 802.11 to establish a wireless local area network (WLAN). In another embodiment, the base station 314b and the WTRUs 308c, 308d may implement a radio technology such as IEEE 802.15 to establish a wireless personal area network (WPAN). In yet another embodiment, the base station 314b and the WTRUs 308c, 308d may utilize a cellular-based RAT (e.g., WCDMA, CDMA2000, GSM, LTE, LTE-A, etc.) to establish a picocell or femtocell. As shown in FIG. 3A, the base station 314b may have a direct connection to the Internet 310. Thus, the base station 314b may not be required to access the Internet 310 via the core network 306.

The RAN 304 may be in communication with the core network 306, which may be any type of network configured to provide voice, data, applications, and/or voice over internet protocol (VoIP) services to one or more of the WTRUs 308a, 308b, 308c, 308d. For example, the core network 306 may provide call control, billing services, mobile location-based services, pre-paid calling, Internet connectivity, video distribution, etc., and/or perform high-level security functions, such as user authentication. Although not shown in FIG. 3A, it will be appreciated that the RAN 304 and/or the core network 306 may be in direct or indirect communication with other RANs that employ the same RAT as the RAN 304 or a different RAT. For example, in addition to being connected to the RAN 304, which may be utilizing an E-UTRA radio technology, the core network 306 may also be in communication with another RAN (not shown) employing a GSM radio technology.

The core network 306 may also serve as a gateway for the WTRUs 308a, 308b, 308c, 308d to access the PSTN 308, the Internet 310, and/or other networks 312. The PSTN 308 may include circuit-switched telephone networks that provide plain old telephone service (POTS). The Internet 310 may include a global system of interconnected computer networks and devices that use common communication protocols, such as the transmission control protocol (TCP), user datagram protocol (UDP) and the internet protocol (IP) in the TCP/IP internet protocol suite. The networks 312 may include wired or wireless communications networks owned and/or operated by other service providers. For example, the networks 312 may include another core network connected to one or more RANs, which may employ the same RAT as the RAN 304 or a different RAT.

Some or all of the WTRUs 308a, 308b, 308c, 308d in the communications system 300 may include multi-mode capabilities, i.e., the WTRUs 308a, 308b, 308c, 308d may include multiple transceivers for communicating with different wireless networks over different wireless links. For example, the WTRU 308c shown in FIG. 3A may be configured to communicate with the base station 314a, which may employ a cellular-based radio technology, and with the base station 314b, which may employ an IEEE 802 radio technology.

FIG. 3B is a system diagram of an example WTRU 308. As shown in FIG. 3B, the WTRU 308 may include a processor 318, a transceiver 320, a transmit/receive element 322, a speaker/microphone 324, a keypad 326, a display/touchpad 328, non-removable memory 330, removable memory 332, a power source 334, a global positioning system (GPS) chipset 336, and other peripherals 338. It will be appreciated that the WTRU 308 may include any sub-combination of the foregoing elements while remaining consistent with an embodiment.

The processor 318 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 318 may perform signal coding, data processing, power control, input/output processing, and/or any other functionality that enables the WTRU 308 to operate in a wireless environment. The processor 318 may be coupled to the transceiver 320, which may be coupled to the transmit/receive element 322. While FIG. 3B depicts the processor 318 and the transceiver 320 as separate components, it will be appreciated that the processor 318 and the transceiver 320 may be integrated together in an electronic package or chip.

The transmit/receive element 322 may be configured to transmit signals to, or receive signals from, a base station (e.g., the base station 314a) over the air interface 316. For example, in one embodiment, the transmit/receive element 322 may be an antenna configured to transmit and/or receive RF signals. In another embodiment, the transmit/receive element 322 may be an emitter/detector configured to transmit and/or receive IR, UV, or visible light signals, for example. In yet another embodiment, the transmit/receive element 322 may be configured to transmit and receive both RF and light signals. It will be appreciated that the transmit/receive element 322 may be configured to transmit and/or receive any combination of wireless signals.

In addition, although the transmit/receive element 322 is depicted in FIG. 3B as a single element, the WTRU 308 may include any number of transmit/receive elements 322. More specifically, the WTRU 308 may employ MIMO technology. Thus, in one embodiment, the WTRU 308 may include two or more transmit/receive elements 322 (e.g., multiple antennas) for transmitting and receiving wireless signals over the air interface 316.

The transceiver 320 may be configured to modulate the signals that are to be transmitted by the transmit/receive element 322 and to demodulate the signals that are received by the transmit/receive element 322. As noted above, the WTRU 308 may have multi-mode capabilities. Thus, the transceiver 320 may include multiple transceivers for enabling the WTRU 308 to communicate via multiple RATs, such as UTRA and IEEE 802.11, for example.

The processor 318 of the WTRU 308 may be coupled to, and may receive user input data from, the speaker/microphone 324, the keypad 326, and/or the display/touchpad 328 (e.g., a liquid crystal display (LCD) display unit or organic light-emitting diode (OLED) display unit). The processor 318 may also output user data to the speaker/microphone 324, the keypad 326, and/or the display/touchpad 328. In addition, the processor 318 may access information from, and store data in, any type of suitable memory, such as the non-removable memory 330 and/or the removable memory 332. The non-removable memory 330 may include random-access memory (RAM), read-only memory (ROM), a hard disk, or any other type of memory storage device. The removable memory 332 may include a subscriber identity module (SIM) card, a memory stick, a secure digital (SD) memory card, and the like. In other embodiments, the processor 318 may access information from, and store data in, memory that is not physically located on the WTRU 308, such as on a server or a home computer (not shown).

The processor 318 may receive power from the power source 334, and may be configured to distribute and/or control the power to the other components in the WTRU 308. The power source 334 may be any suitable device for powering the WTRU 308. For example, the power source 334 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 318 may also be coupled to the GPS chipset 336, which may be configured to provide location information (e.g., longitude and latitude) regarding the current location of the WTRU 308. In addition to, or in lieu of, the information from the GPS chipset 336, the WTRU 308 may receive location information over the air interface 316 from a base station (e.g., base stations 314a, 314b) and/or determine its location based on the timing of the signals being received from two or more nearby base stations. It will be appreciated that the WTRU 308 may acquire location information by way of any suitable location-determination method while remaining consistent with an embodiment.

The processor 318 may further be coupled to other peripherals 338, which may include one or more software and/or hardware modules that provide additional features, functionality and/or wired or wireless connectivity. For example, the peripherals 338 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 3C is a system diagram of the RAN 304 and the core network 306 according to an embodiment. As noted above, the RAN 304 may employ an E-UTRA radio technology to communicate with the WTRUs 308a, 308b, 308c over the air interface 316. The RAN 304 may also be in communication with the core network 306.

The RAN 304 may include eNode-Bs 340a, 340b, 340c, though it will be appreciated that the RAN 304 may include any number of eNode-Bs while remaining consistent with an embodiment. The eNode-Bs 340a, 340b, 340c may each include one or more transceivers for communicating with the WTRUs 308a, 308b, 308c over the air interface 316. In one embodiment, the eNode-Bs 340a, 340b, 340c may implement MIMO technology. Thus, the eNode-B 340a, for example, may use multiple antennas to transmit wireless signals to, and receive wireless signals from, the WTRU 308a.

Each of the eNode-Bs 340a, 340b, 340c may be associated with a particular cell (not shown) and may be configured to handle radio resource management decisions, handover decisions, scheduling of users in the uplink and/or downlink, and the like. As shown in FIG. 3C, the eNode-Bs 340a, 340b, 340c may communicate with one another over an X2 interface.

The core network 306 shown in FIG. 3C may include a mobility management gateway (MME) 344, a serving gateway 346, and a packet data network (PDN) gateway 348. While each of the foregoing elements are depicted as part of the core network 306, it will be appreciated that any one of these elements may be owned and/or operated by an entity other than the core network operator.

The MME 344 may be connected to each of the eNode-Bs 340a, 340b, 340c in the RAN 304 via an S1 interface and may serve as a control node. For example, the MME 344 may be responsible for authenticating users of the WTRUs 308a, 308b, 308c, bearer activation/deactivation, selecting a particular serving gateway during an initial attach of the WTRUs 308a, 308b, 308c, and the like. The MME 344 may also provide a control plane function for switching between the RAN 304 and other RANs (not shown) that employ other radio technologies, such as GSM or WCDMA.

The serving gateway 346 may be connected to each of the eNode Bs 340a, 340b, 340c in the RAN 304 via the S1 interface. The serving gateway 346 may generally route and forward user data packets to/from the WTRUs 308a, 308b, 308c. The serving gateway 346 may also perform other functions, such as anchoring user planes during inter-eNode B handovers, triggering paging when downlink data is available for the WTRUs 308a, 308b, 308c, managing and storing contexts of the WTRUs 308a, 308b, 308c, and the like.

The serving gateway 346 may also be connected to the PDN gateway 348, which may provide the WTRUs 308a, 308b, 308c with access to packet-switched networks, such as the Internet 310, to facilitate communications between the WTRUs 308a, 308b, 308c and IP-enabled devices.

The core network 306 may facilitate communications with other networks. For example, the core network 306 may provide the WTRUs 308a, 308b, 308c with access to circuit-switched networks, such as the PSTN 308, to facilitate communications between the WTRUs 308a, 308b, 308c and traditional land-line communications devices. For example, the core network 306 may include, or may communicate with, an IP gateway (e.g., an IP multimedia subsystem (IMS) server) that serves as an interface between the core network 306 and the PSTN 308. In addition, the core network 306 may provide the WTRUs 308a, 308b, 308c with access to the networks 312, which may include other wired or wireless networks that are owned and/or operated by other service providers.

The duplication of a video and/or audio stream may be desirable for a number of reasons. For example, a person may be watching a movie at home with family and/or friends, and the person receives a phone call requiring him/her to leave the house. In this case, the person may want to duplicate the video stream on his/her cellular phone while his family and/or friends continue to watch the movie on the screen at home. Control of the video stream may remain in the hands of those watching the video at home, with the user leaving, or with both. In another example, a person may be involved in a video conference and may want to duplicate the video session, audio session, or both, on his/her cellular phone as the person steps out of the conference room. If the person returns to the conference room, they may desire to stop the duplicated session. This duplication may be in, for example, an AMS type of system.

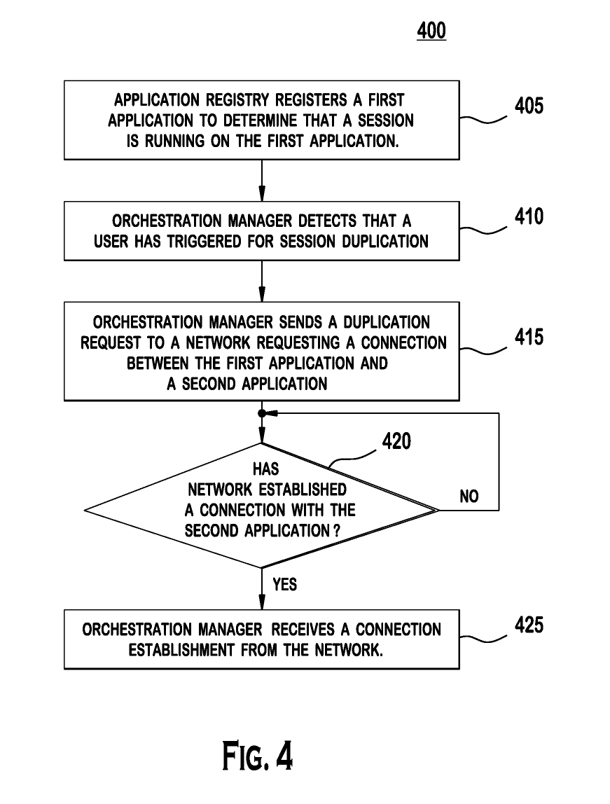

FIG. 4 is a block diagram of a session duplication scenario 400 from a mediation device (i.e., a WTRU) perspective. The AR registers a first application to determine that a session is running on the first application 405. The OM detects that a user has triggered a session duplication 410. The OM sends a duplication request message to a network requesting a connection between the first application and a second application 415. It is determined whether the network has established a connection with the second application 420. On a condition that the network has established a connection with the second application, the OM receives a connection establishment from the network 425. On a condition that the network has not established a connection with the second application, the determination of whether a connection can be established with the second application is repeated 420.

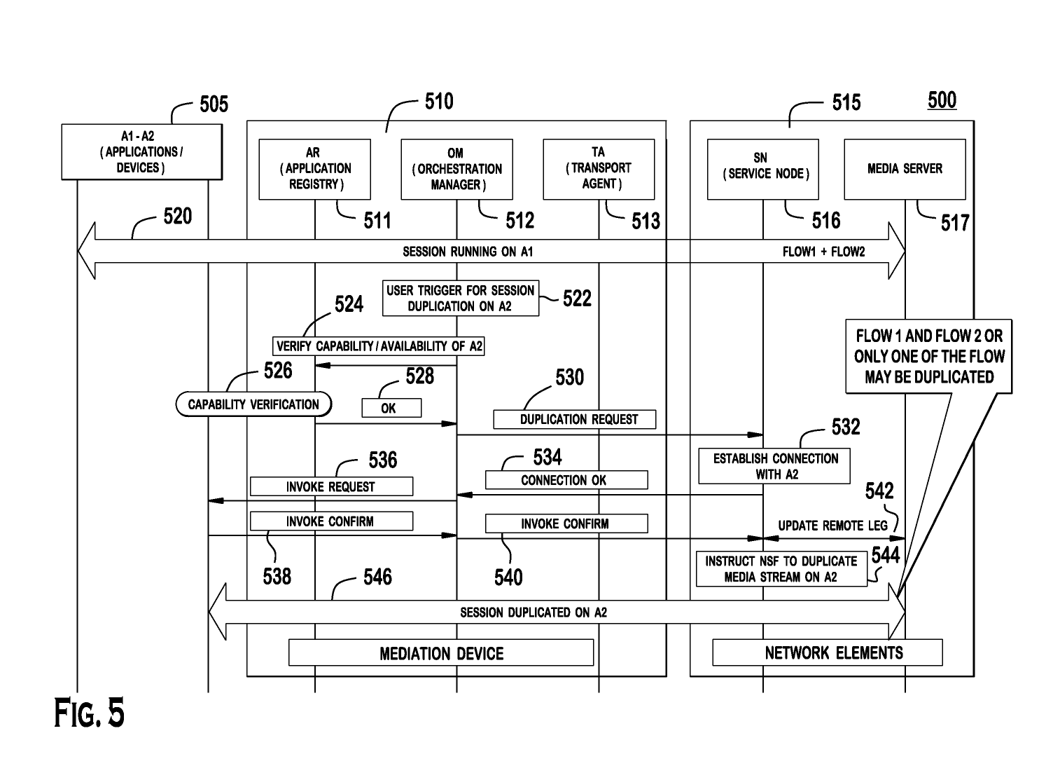

FIG. 5 shows a signal diagram of a session duplication scenario 500. A mediation device 510 includes an AR 511, an OM 512, and a TA 513. The network elements 515 include a SN 516 and a media server 517. There may be any number of applications or devices 505. A session may be running on a first application, or device, such as A1 520. The session may include flows, for example, Flow1 and Flow2. The flows may be audio and/or video data. A trigger may occur, which may be a user trigger for duplication of the session on a second application or device 522. The second application or device A2 may or may not be part of the mediation device. The trigger may occur in the OM 512 within the mediation device 510, which may be for example, a cell phone. Although only two applications, A1 and A2 505, are depicted for example purposes, any number of applications or devices may be utilized.

The capability and/or availability of A2 may be verified 524 via a message from the OM to the AR, and capability verification may occur 526. The capability verification may be performed between A2 and the AR. An OK message may be sent 528 from the AR 511 to the OM 512. A duplication request message may be sent 530 from the OM 512 to a SN 516 via the TA 513.

Establishment of a connection for A2 may occur 532 at the SN 516, and a connection OK message may be sent 534 by the SN 516 to the OM 512 via the TA 513. An invoke request message may be sent 536 from the OM 512 to the second application (i.e., A2) via the AR 511, and an invoke confirm message may be sent 538 from the second application, A2, to the OM 512. Another invoke confirm message may be sent 540 from the OM 512 to the SN 516. The remote leg may be updated 542 between the SN 516 and the media server 517, and the SN 516 may instruct the NSF to duplicate the media stream running 544 on the first application (i.e., A1) onto the second application (i.e., A2). The session may be duplicated on the second application, A2 546. It should be noted that either Flow1, Flow2, or both Flow1 and Flow 2 may be duplicated. Any number of Flows can be included here, but only two are shown for simplicity.

For purposes of example, the AR 511, the OM 512, the TA 513, and the A2 505 may exist in a mediation device, such as a cell phone, and the SN 516 and the media server 517 may exist in a network element 515.

The sharing of media may be desirable for a number of reasons. For example, a user may go on a vacation where he has taken a large number of photographs using his mobile phone. He may desire to show the photographs to friends and/or relatives on a large screen television (TV) that does not support the format of his mobile phone photographs, and may not have had the time or opportunity to convert the photographs or store them on, for example, a storage server or media card. Accordingly, he may activate an application on his cellular phone that projects a slide show onto the TV, and may want to use his cellular phone to control the slide show, skipping pictures, re-sizing pictures, zooming, rotating, and the like.

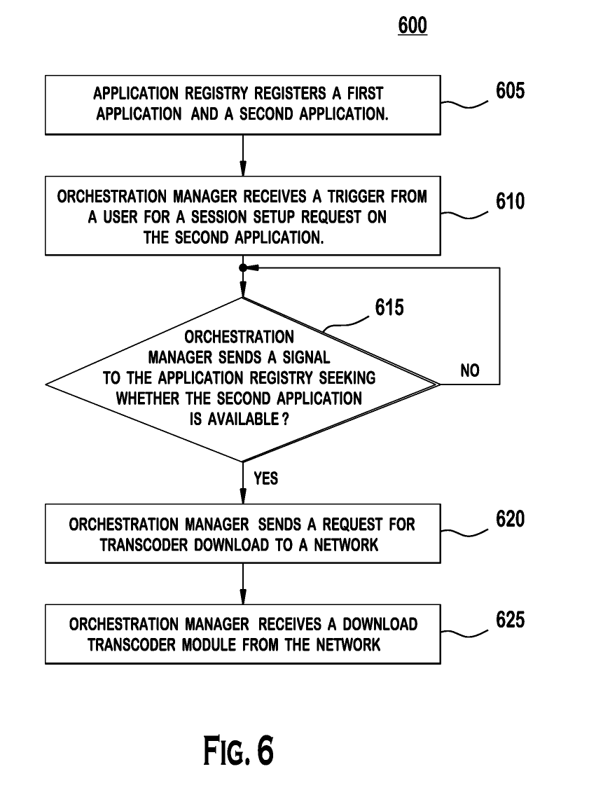

FIG. 6 shows a flow diagram 600 proposed for a media sharing scenario. The AR registers a first application and a second application 605. The OM receives a trigger from a user for a session setup request on the second application 610. The OM sends a message to the AR seeking availability and capability of the second application 615. On a condition that the second application available, the OM sends a request for transcoder download to a network 620. The OM receives a download transcoder module from the network 625.

Typically, transcoding takes place in the network that has a separate node, which performs transcoding. This may not be suitable and/or efficient for media shared locally because a local video may be shared that needs to be transcoded in the network. The method and apparatus described herewith performs transcoding algorithm and downloads the associated code from the network to the container, which is a local entity. The media is transcoded using the downloaded codec. Hence, time and bandwidth are saved. The result is much faster video/photo sharing among local device.

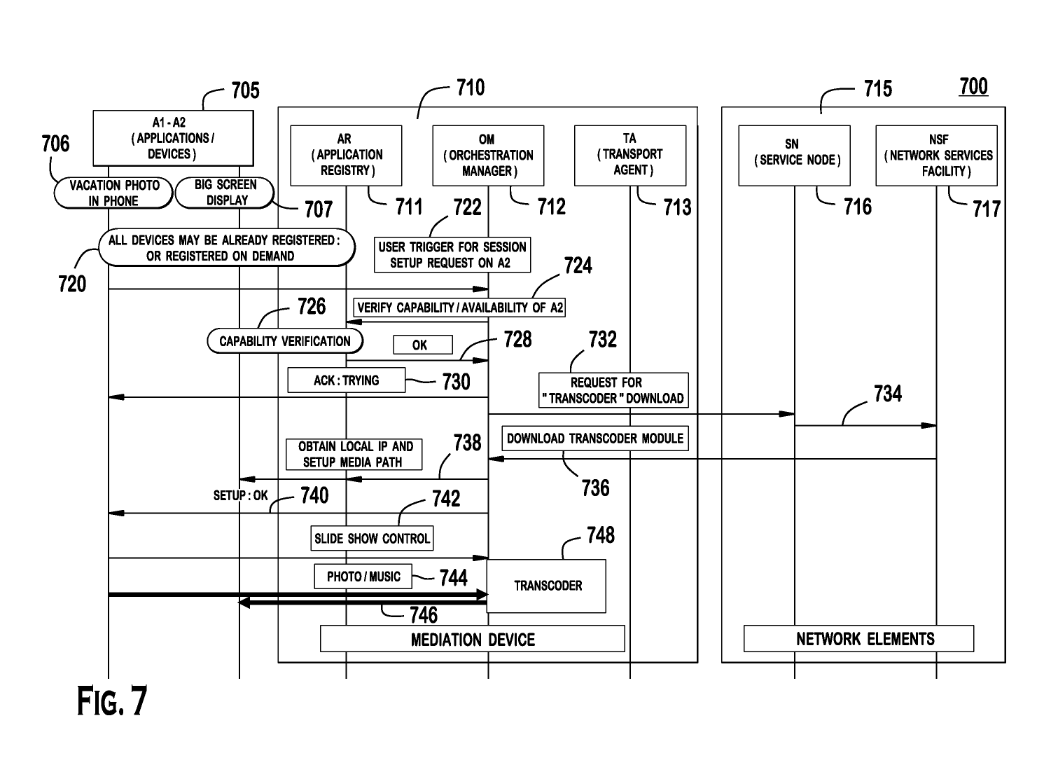

FIG. 7 shows a signal diagram 700 of a media sharing scenario. In this embodiment, vacation photos are in a first application or device (A1) 706. A display, such as a big screen display may be for a second application or device (A2) 707. The applications or device A1 and A2 may already be registered with the AR or they may be registered on demand with the AR 720.

A trigger may occur at the OM 712 to trigger for a session setup on the application or device A2 722. The trigger may be a user trigger and may be performed by the application or device A1 to the OM 712. The capability and/or availability of A2 may be verified 724 via a message from the OM 712 to the AR 711, and capability verification may occur 726. An OK message may be sent 728 from the AR 711 to the OM 712. The capability verification may be performed 726 between A2 707 and the AR 711. A trying acknowledgment (ACK) may be sent 730 from the OM 712 to A1 706, and a request for transcoder download may be sent 732 from the OM 712 to the SN 716, via the TA 713. The SN 716 may signal the request for transcoder download to the NSF 717. The transcoder module may be downloaded 736 by the OM 712 from the NSF 717 via the TA 713. A local IP may be obtained and the media path may be setup 738 from the OM 712 to the A2 707 via the AR 711.

A determination of the setup being complete may be made 740 at the A2 707. This may be signaled to the A1 706 by the OM 712. The media, such as photos and/or music 744, and control of the media, (e.g., slide show control) 742 may be received by the transcoder 748 from the first application or device A1 706 and transmitted 746 by the transcoder 748 to the second application or device A2 707.

For purposes of example, the AR, OM, TA, and A1 may exist in a mediation device, such as a cellphone, and the SN and NSF may exist in network elements. Although the examples described herewith depict the sharing of photos such as vacation photos, it is to be noted that any type of media may be shared. Although only two applications, A1 and A2, are depicted for example purposes, any number of applications or devices may be utilized.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A mediation device for use in an H.325 network, the mediation device comprising:
an application registry configured to register an application and determine whether a session is running on a first application; and
an orchestration manager configured to:
detect that a user has triggered a session duplication on a second application,
send a duplication request to a network for a connection establishment between the first application and the second application, and
receive a message confirming the connection establishment from the network on a condition that the network has initiated connection establishment with the second application.

2. The mediation device as in claim 1 wherein the orchestration manager is configured to receive a connection OK message from the network.

3. The mediation device as in claim 2 wherein the orchestration manager is configured to send an invoke request to the second application as part of the connection establishment.

4. The mediation device as in claim 3 wherein the orchestration manager is configured to receive an invoke confirmation from the second application.

5. The mediation device as in claim 4 wherein the orchestration manager is configured to send the invoke confirmation to the network for a session duplication.

6. The mediation device as in claim 1 wherein the application registry, the orchestration manager, and a transport agent are subfuctions of a container function.

7. The mediation device as in claim 6 wherein the container function is an H.325 container function.

8. A mediation device for use in an H.325 network, the mediation device comprising:
an application registry configured to register a first application and a second application;
an orchestration manager configured to receive a trigger for a session setup request on the second application;
the orchestration manager configured to send a message to the application registry seeking whether the second application is available and that the second application is capable of running same session as the one running on the first application; and
upon receiving an acknowledgement of verification, the orchestration manager configured to send a request for transcoder download to a network.

9. The mediation device as in claim 8 wherein transcoding algorithm and associated code is downloaded from the network to a local entity.

10. The mediation device as in claim 8 wherein the application registry, the orchestration manager, and a transport agent are subfuctions of a container function.

11. The mediation device as in claim 10 wherein the container function is an H.325 container function.

12. A computer-readable storage medium containing instructions, which when executed in a mediation device for use in an H.325 network, cause the mediation device to perform a method, the method comprising:
registering a first application and a second application;
receiving a trigger for a session setup request on the second application;
sending a message seeking whether the second application is available and that the second application is capable of running same session as the one running on the first application; and
upon receiving an acknowledgement of verification, sending a request for transcoder download to a network.

13. The computer-readable storage medium as in claim 12 wherein transcoding algorithm and associated code is downloaded from the network to a local entity.

14. The computer-readable storage medium as in claim 12 wherein the mediation device is located within a H.325 device.
